(19) United States
(12) Patent Application Publication
(10) Pub. No.: US 2014/0059132 A1
(43) Pub. Date: Feb. 27, 2014

(54) METHOD FOR EVENT SOCIAL INTERACTION USING A NETWORK

(71) Applicant: MySeat.com Media Inc., Pointe Claire (CA)

(72) Inventors: Steven SHELTON, Pointe Claire (CA); Normand PIGEON, Cookshire-Eaton (CA); Che HODGINS, Verdun (CA)

(73) Assignee: MySeat.com Media Inc., Pointe Claire (CA)

(21) Appl. No.: 13/970,835

(22) Filed: Aug. 20, 2013

Related U.S. Application Data
(60) Provisional application No. 61/691,441, filed on Aug. 21, 2012.

(51) Int. Cl. H04L 29/06

(52) U.S. Cl. CPC H04L 65/40
USPC 709/204

(57) ABSTRACT

An event is associated with a first individual. A second individual is associated with the first individual and with the event. Proximate the time of the event, the presence of the second individual at a venue for participating in the event is sensed with an electronic sensor in communication with the Internet. Then, a notification message is transmitted to the electronic communication device of the first individual notifying the individual of the presence at the venue of the second individual at the event venue.

### FIELD OF THE INVENTION

The invention relates to the field of social networking and more particularly to the field of event based social networking.

### BACKGROUND

Social networking is a term that is applied to World Wide Web sites that incorporate a social aspect into their services. At first, social networking sites allowed for storage and retrieval of personal data beyond merely directory data.

One of the first popular social networking sites was MySpace®. MySpace® allowed users to define a space within their site that was personal to the user and reflected user taste, data, and connections. More recently Facebook® has become one of the largest social networking sites in the world. One advantage that Facebook® presented early on, was the ability to use the social networking site to arrange social events. One could post on their wall that they were going to a certain club and their friends would be able to comment—indicate that they were going. It was like telling your friends what you were doing and hearing their replies but over the Internet instead of in person. Also, it allowed your friends to see each other's replies as if you had invited them all at the end of a class.

Unfortunately, with its wider dissemination, Facebook® has become less a tool for actual interaction and more a tool for virtual interaction. This is not a criticism as much can be accomplished through virtual interaction—photo sharing, messaging, email, status updates, and sharing of personal information, for example. That said, we are social beings and human interaction on a physical and local scale remain desirable.

The term “social networking” is also applied to tools that allow for social communication, such as Twitter® and to other sites/tools that enhance a user's social experience within the World Wide Web. These services maintain a list of social connections and are therefore considered social.

It would, however, be highly beneficial to apply social networking to physical networking and to physical events—events where those socializing are actually present. Unfortunately, none of the existing tools supports a richly featured interactive networking solution.

### SUMMARY OF THE INVENTION

In accordance with an aspect of the invention there is provided a method comprising providing an event in association with a first individual having an electronic communication device in communication with a communication network providing a second individual associated with the first individual and with the event, an indication of the second individual stored in an electronic data store, data from the electronic data store accessible to the electronic communication device; proximate a time of the event, sensing with an electronic sensor in communication with the communication network a presence of the second individual at a venue for participating in the event; transmitting a notification message via the communication network to the electronic communication device of the individual indicative of the presence of the second individual at the venue for participating in the event; and notifying the first individual of the presence at the venue of the second individual via a transducer of the electronic communication device.

In accordance with an aspect of the invention there is provided a method comprising joining an event by a first individual having a first electronic communication device in communication with a communication network; joining the event by a second individual having a second electronic communication device in communication with the communication network; opening a communication channel in the communication network between the first electronic communication device and the second electronic communication device based on the first individual and the second individual being friends via a third party social network; and defining a sub-event between the first individual and the second individual for a time other than during the event activity via the communication channel.

In accordance with an aspect of the invention there is provided a method comprising joining an event by a first individual having a first electronic communication device in communication with a communication network; joining the event by a second individual having a second electronic communication device in communication with the communication network; and creating a link between the first individual and the second individual within the event based on the first individual and the second individual being friends via a third party social network.

In accordance with an aspect of the invention there is provided a method comprising providing a first electronic communication device in communication with a communication network; providing a first social network in operation and accessible via the communication network, the first social network in operation other than within the first electronic communication device; providing a first individual, the first individual being a member of the first social network and having friends within the first social network and the first individual for operating the first electronic communication device; joining an event by the first individual having the first electronic communication device; performing an intersection between individuals who have joined the event and friends of the first individual within the first social network, the intersection resulting in a group for interacting about the event that are socially connected within the first social network; and providing social engagement between members of the group.

In accordance with an aspect of the invention there is provided a method comprising scanning a portion of a ticket for ticket data relating to an event and an individual by an electronic device, the electronic device in communication with a communication network; searching for first event data relating to the individual in an event data store, the event data store in communication with the communication network; when the first event data is other than found, storing first event data relating to the individual in the event data store via the communication network; and storing the ticket data in the event data store, the ticket data relating to the individual, the actual event, and the ticket data via the communication network.

In accordance with an aspect of the invention there is provided a method comprising providing an event in association with a first individual having an electronic communication device in communication with a communication network; using the electronic communication device to search for a second individual attending the event, people having checked in to the event; and in response to the search, notifying the first individual of the presence at the venue of the second individual via a transducer of the electronic communication device.

In accordance with an aspect of the invention there is provided a method comprising providing an event in association with a first individual having an electronic communication device in communication with a communication network; using the electronic communication device to retrieve a list of those individuals in attendance and data associated therewith which is available for access by the first individual via the communication network; and displaying via a transducer of the electronic communication device the retrieved list.

### BRIEF DESCRIPTION OF THE DRAWINGS

FIG. 1 is a simplified diagram of a social network webpage according to the prior art.

FIG. 2 is simplified diagram of a social network webpage according to an embodiment of the invention.

FIG. 3 is a simplified diagram of a social network according to an embodiment of the invention.

FIG. 4 is a simplified flow diagram of a method for notifying friends of the arrival of an individual.

FIG. 5 is another simplified flow diagram of a method for adding event entries to be shared with friends.

FIG. 6 is a simplified flow diagram of a method for displaying notifications.

FIG. 7A is a first list of 12 friends, 4 of which have arrived at the event.

FIG. 7B is a second list of 12 friends, 6 of which have arrived at the event.

FIG. 8 is a simplified flow diagram of reserving space for before or after an event in the form of a hockey game.

FIG. 9 is another simplified flow diagram 900 of reserving space for before or after and event in the form of a hockey game.

FIG. 10 is a seating chart of the hockey arena.

FIG. 11 is a simplified flow diagram of scanning a ticket in order to join an event in the form of a hockey game.

FIG. 12 is a flow diagram for scanning tickets according to an embodiment of the invention.

FIG. 13 is a simplified diagram of an individual receiving notifications of the event activity of a celebrity.

FIG. 14 is a simplified diagram of an individual searching lists of individuals that have joined an event.

FIG. 15 is a simplified diagram of a second individual receiving notifications of the event activity of a first individual.

FIG. 16 is another simplified diagram of an individual searching lists of individuals that have joined an event.

FIG. 17 is a simplified diagram of a first individual determining the location of a second individual, both of whom have joined the same event.

FIG. 18 is another simplified diagram of a first individual determining the location of a second individual, both of whom have joined the same event.

### DETAILED DESCRIPTION

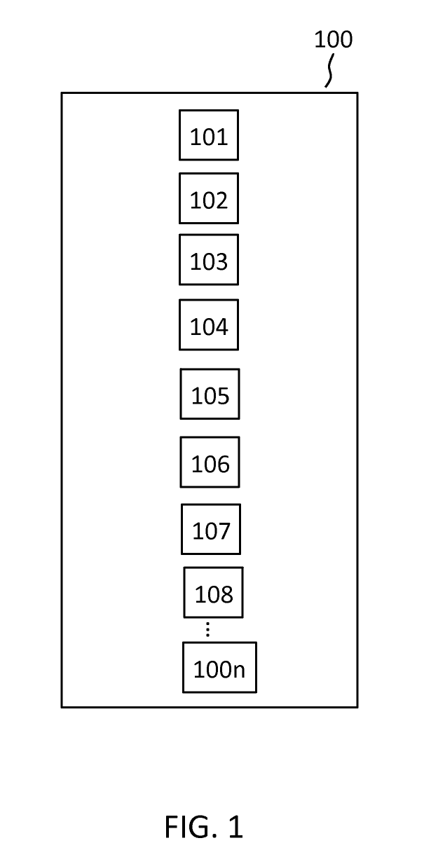

Referring to FIG. 1, shown is a simplified diagram of a social network webpage according to the prior art. A user has provided their personal information including preferences, likes and dislikes. They have also linked up with a number of friends and have a “wall” on which friends post notes and messages. A news feed tells the individual what has been placed on peoples walls, what statuses people have provided, and highlights other noteworthy events that users linked to the individual have entered into their “page.” For example, the user's Facebook® page 100 shows the following posts: Gordon (the user) joins Facebook® (101); Gordon friended Sue (102); Gordon is married to Rashell (103); Gordon likes Ashley's cupcakes (104); Gordon is going to the hockey game (105); Gordon likes summer (106); Gordon is feeling tired all day (107); Gordon friended John (108) . . . Ashley's Cupcakes has a special today (100n).

Unfortunately, the social network of FIG. 1 relates to data entry of individuals and fails to adequately provide real life social experiences involving two or more people sharing an event together.

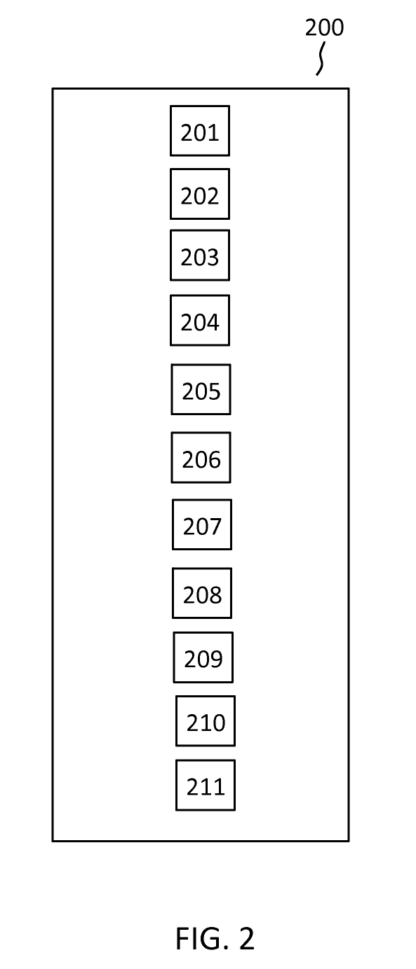

Referring now to FIG. 2, shown is simplified diagram of a social network webpage according to an embodiment of the invention. Here, an individual is linked to a number of “friends.” This, for example, is accomplished via the social network of FIG. 1, an existing third party social network, or a social network specific for the present purpose. When the individual attends an event, for example a sporting event, the individual is notified of linked individuals who are also present at the sporting event. In this way, the individuals share the event and can socialize during the event with each other. For example, the individual's Facebook® page 200 shows the following posts: Gordon joins Facebook® (201); Gordon friended Sue (202); Gordon is married to Rashell (203); Gordon likes Ashley's cupcakes (204); Gordon is going to the hockey game on November 15th (205); Gordon likes summer (206); Gordon is feeling tired all day (207); Gordon friended John (208). The next item posted on Gordon's Facebook® page, Gordon arrived at the hockey game (209), is automatically generated when Gordon's ticket is scanned upon entry at the hockey game. Furthermore when Gordon's friends arrive at the hockey game, and their tickets are scanned, the posts, Rashell arrived at the hockey game (210) and John arrived at the hockey game (211) are automatically generated and posted on Gordon's Facebook® page. Gordon now knows that his friends Rashell and John are attending the same game as him and Gordon can contact them to meet up for after game drinks.

Alternatively, the post, Gordon has arrived at the hockey game (209), is automatically posted when the GPS in Gordon's smartphone detects that he has entered the hockey arena. Further alternatively, the post, Gordon has arrived at the hockey game (209), is automatically posted when Gordon enters data into a software program via a media interface indicating his arrival at the hockey arena.

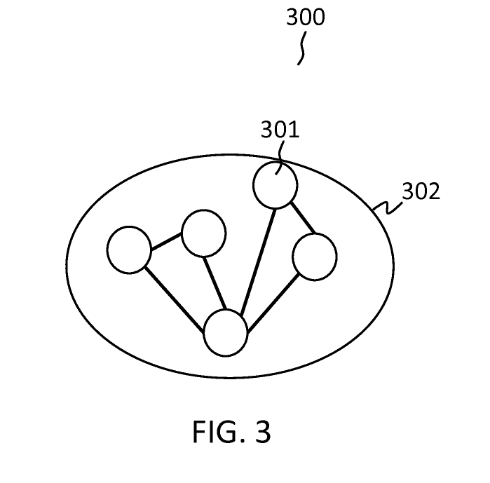

Referring to FIG. 3, shown is a simplified diagram of a social network (300) according to another embodiment of the invention. Here, individuals (301) have a social group (302), commonly referred to as friends within the social network. For example the social network comprises a group of friends on Facebook®. Alternatively, another social network is used. Further, individuals are provided an opportunity to join events. Optionally, a plurality of social networks are used simultaneously and bridged by an event. Optionally, when an individual joins an event, their friends are notified of this. For example, notifications are provided via one or more social networks to their friends. Alternatively, their friends are notified via communication methodologies outside the social networks. Further optionally, only other friends who have joined the same event are notified. Yet further, no one is notified.

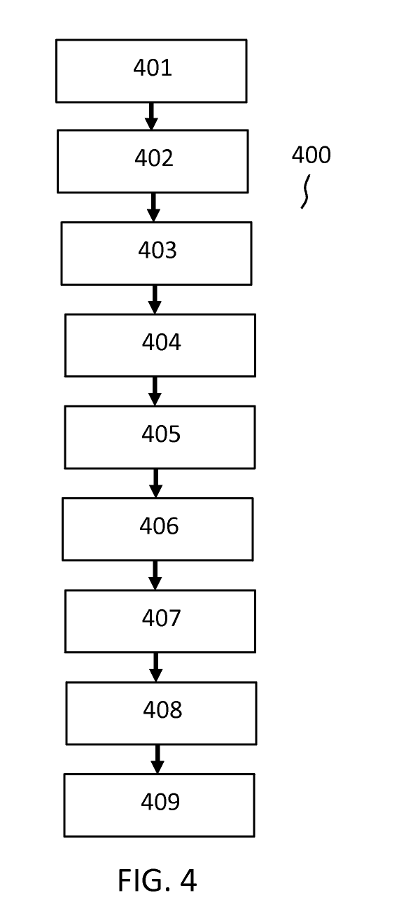

At some time after joining an event, the individual attends the event or participates therein. At that time, the social network enhances social engagement in relation to the event by linking the friends who are participating in the event allowing for inter-friend communication, sharing of photos, and sharing of other event related data. A more clear example is provided with reference to FIG. 4 and the specific example of a sporting event in the form of a hockey game.

Referring to FIG. 4, shown is a simplified flow diagram of a method of sharing event related data with friends. An individual purchases a ticket for a hockey game (401), scans the ticket (402) and the hockey game event is joined (403). For example, scanning of the ticket is performed by taking a photograph of the ticket and processing the photograph to extract therefrom ticket information. Once the event is joined, the individual and the event are stored within a social network data store (404). The individual can add entries to the “event” within their social network data store such as preparations, comments, predictions, and so forth (405) which are shared with his friends.

When the individual arrives at the event (406), this is detected (407) or, alternatively the individual enters data to this effect, and friends who are also at the event are notified that the individual has arrived (408).

For venue events, this allows an individual to know who is there. This also allows an individual to know which people they can interact with during the event who are also in attendance (409). For example, shared messaging between individuals in attendance is initiated and, as such, they can converse by way of messaging as if they were all sitting together. Alternatively, shared communication is set up so they can converse by videoconference or voice conference.

Optionally, when the individual leaves the event, the friends are notified of this as well.

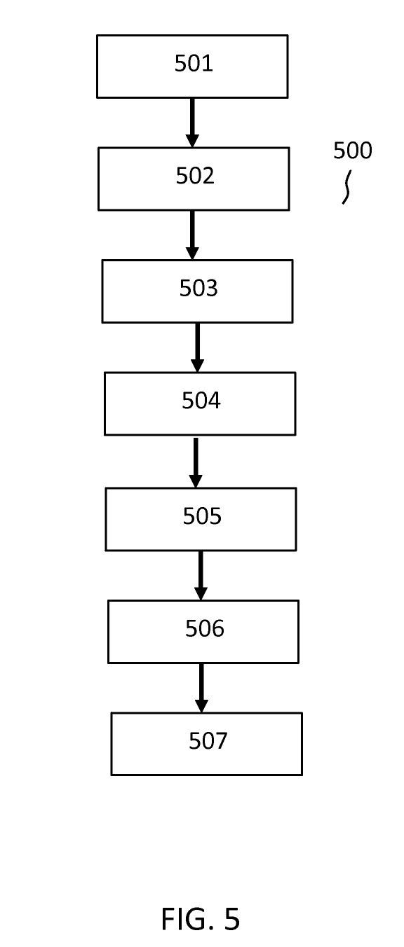

Referring to FIG. 5, shown is a simplified flow diagram of a method of interacting with friends during the event. An event in the form of a hockey game on November 15th is joined when the individual decides to attend (501). Once the event is joined, the individual and the event are stored within a social network data store (502). The individual can add entries to the “event” within their social network data store such as preparations, comments, predictions, and so forth (503), which are shared with his friends.

When the individual attends the event (504), this is detected automatically (505) or, alternatively, the individual enters data to this effect, and friends who are also at the event are notified that the individual has arrived (506). The friend need not be at the event venue to attend the event. For example, audio fingerprinting is used to determine that the individual has begun watching the game on television. Of course, the audio fingerprinting optionally works in sports bars and other public places where the individual can watch the game.

This allows an individual to know which people they can interact with during the event who are also watching or otherwise involved (507). For example, shared messaging between individuals is initiated and, as such, they can converse by way of messaging as if they were all sitting together. Alternatively, shared communication is set up so they can converse by videoconference or voice conference.

Optionally, when the individual leaves the event or stops watching, the friends are notified of this as well.

Alternatively, some friends are watching the event on television while others are in attendance. Yet further alternatively, some friends are located proximate the game while others are far away, for example on another continent. Even when this is the case, the individual friends can share the social experience of the event together as a group.

Of course, the shared event need not stop immediately after the game finishes. For example, some of the friends can meet at a restaurant or bar after the game. Alternatively friends meet in two or more separate locations to socialize but the locations are linked via the social networking communication tool to allow intergroup communication. Such a link is optionally group-to-group. Further optionally, such a link is individual-to-individual or individual-to-group allowing for separate cocktail chats within a larger group to be private or semi private making for group communications to be more realistic.

Advantageously, friends who attend an event can share entries and events. For example, a photograph taken of a server dropping an entire tray of beer on someone can be shared amongst the group such that they all chuckle together at the server's misfortune. Similarly, a strange experience at the sports bar can be captured on video and shared amongst the group.

Preferably, events are shared in at least a timeline of the event such that revisiting the event or remembering the event as it happened to an individual personally is enhanced. Sharing of timelines or private entries is optional, but the experience of the individual can be captured including what they saw of the event, what happened to them that they recorded or commented about, and what happened to others that was shared with them or communicated to them. In theory, after an event an individual could walk through or recreate the event as they experienced it the first time; nearly identically if they watched the game on television by replaying the game and synchronizing events to what happened as they did while watching the game. Thus each message, each conversation, notification of a friend's arrival and each friend's communications are repeated in synchronization with the actual hockey game.

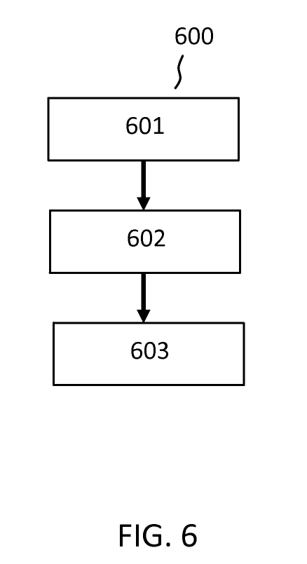

Referring to FIG. 6, shown is a simplified flow diagram 600 of another method of displaying notifications. Here, instead of notifying each individual within a group of friends when a friend arrives, a list is maintained of who is expected and who has arrived. For example, when friends join an event (601) a list is created of who is expected to attend the event (602). When a friend arrives at the event the arrival is indicated in the list displayed to the friends (603).

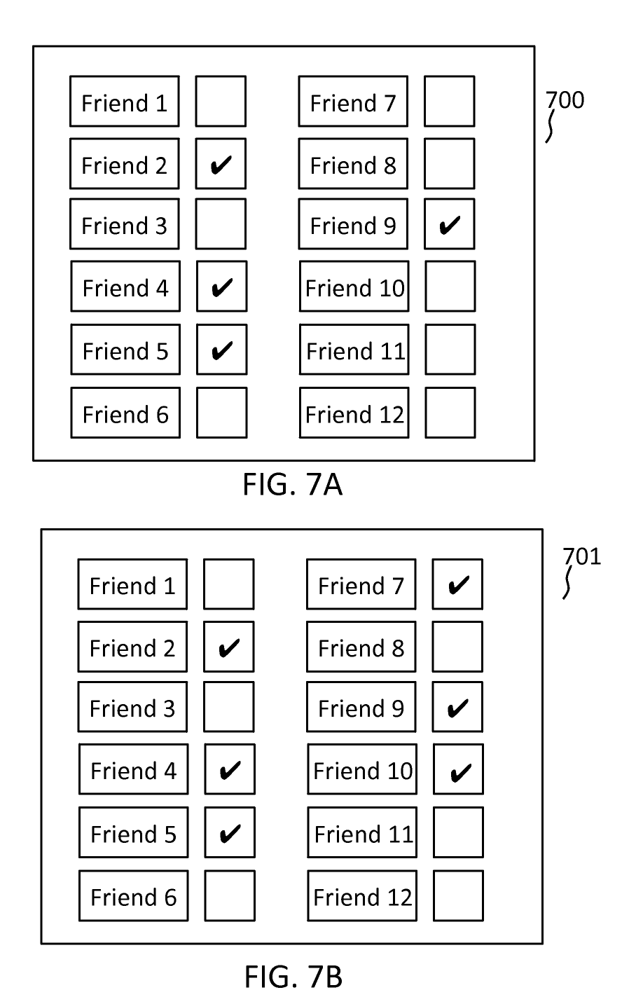

Turning to FIG. 7A, shown is a first list 700 including 12 friends. When the individual arrives, four of the friends are already at the event as indicated in list 700. ten minutes later, six of the friends are there as shown in FIG. 7B in list 701. The individual queries some of the absent friends to determine their status. This information is useful, for example, if the individual was early and decided to get a drink before the game. The individual can get space for the friends that are already there and can query the remaining friends to find out if any of them are almost there such that they can join for a drink. Alternatively, the notification is via an audio signal from a computer, smartphone, or other mobile device. Alternatively, the notification is via an email.

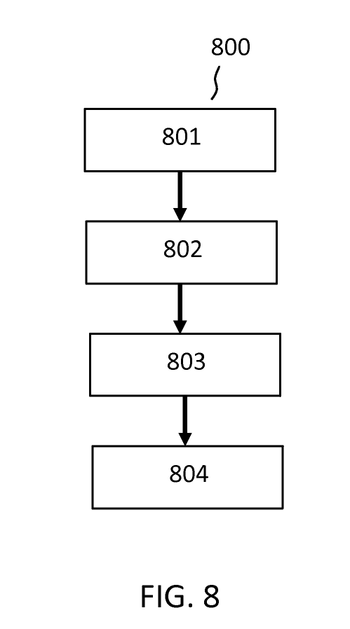

Referring to FIG. 8, shown is a simplified flow diagram 800 of a method for reserving space for before or after an event in the form of a hockey game. The individual decides to go for a drink before the game (801). He sends a notice to all the friends that have joined the event inviting them to have a drink (802). Each friend optionally confirms or refuses the invitation (803). The process then automatically makes the reservation at a nearby sports bar (804). Though this may sound trivial, before a game and thereafter the sports bars immediately adjacent the venue are busy, so the process queries a plurality of restaurants to identify one with sufficient space and availability for the group. Once reservations are made, the friends who have joined the event are re-notified to ensure they know where and when the meet up will occur. Optionally each friend is given a second chance to confirm or refuse attendance.

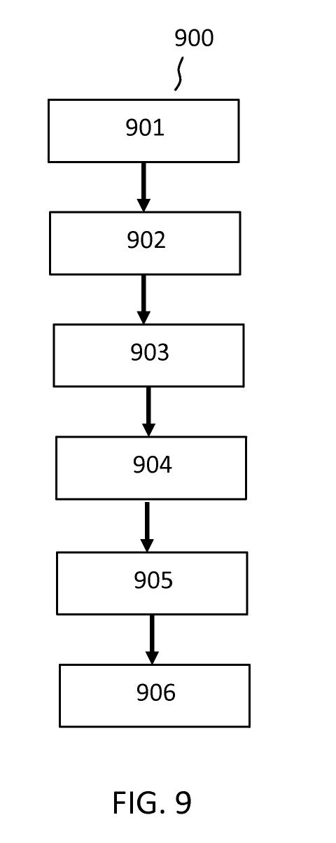

Referring to FIG. 9, shown is a simplified flow diagram 900 of a method for reserving space for before or after an event in the form of a hockey game. The individual decides to go for a drink before the game (901). He sends a notice to all the friends that have joined the event inviting them to have a drink (902). Each friend confirms or refuses the invitation (903). The process then automatically makes the reservation at a nearby sports bar (904). Though this may sound trivial, before a game and thereafter the sports bars immediately adjacent the venue are busy, so the process queries a plurality of restaurants to identify one with sufficient space and availability for the group. Here, a list of preferred restaurants is provided to the individual (905). Alternatively, the preferred restaurant list is automatically determined based on the individual's past behaviour. Further alternatively, the list of restaurants and a priority thereof is determined based on one of group behaviour and group preferences—group behaviors and preferences determined based on behaviors of individuals within the group or preferences of individuals in the group analyzed together. Once reservations are made, the friends who have joined the event are re-notified to ensure they know where and when the meet up will occur (906). Optionally each friend is given a second chance to confirm or refuse attendance. Optionally, the preferred restaurant sends the friends a menu via email or other electronic method and provides the option for the friends to pre-order their meal, reducing their wait time when they arrive at the restaurant.

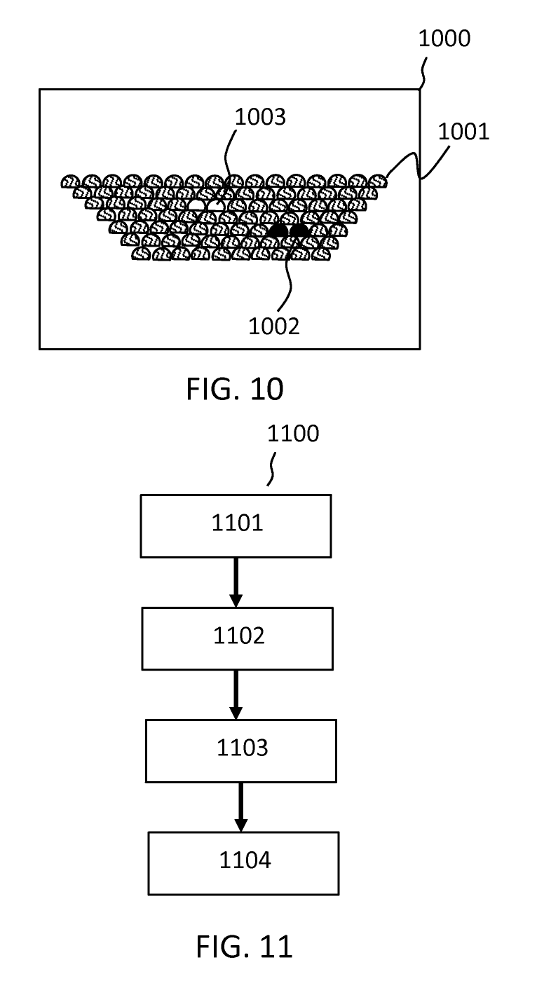

Referring to FIG. 10, shown is a display 1000 for use with yet another method of notifying an individual of friends who are present at the event. Here, a seating diagram 1001 of the venue is shown to the individual. Within the seating diagram are highlighted seats of each friend that has joined the event and intends to attend the venue for the event. Those seats are highlighted one way—dark solid 1002—if the friend is already at the venue and another way—white solid 1003—if the friend is not yet at the venue. Thus, the individual receives a visual indication of the presence/absence of friends and their geographic location for the event. This can help in conversations, during the event such as, “from my side of the rink, you could see . . . ” or, “Lets grab a bite during intermission.” Optionally, the individual zooms in and out of the seating diagram 1001 as well as scrolls the seating diagram 1001 side to side on display 1000 to investigate the locations where the friends are seated.

Alternatively, the seats of friends already at the venue are colour coded based on the social network the friends are associated. For example, the seats are coloured blue if they are friends from Facebook® and are red if they are friends from MySpace®. Alternatively, flags are placed in the seats of friends already at the venue.

An individual's seat data is collected when the individual has joined an event by scanning his ticket or by the individual entering seat data into a software program via a media interface. Once seat data is collected, an individual is detected to be in attendance at the event by cameras at the event venue identifying an individual sitting in the individual's seat. Once the individual has been identified as present a notification is sent to his friends that have also joined the event.

Referring to FIG. 11, shown is a simplified flow diagram 1100 of scanning a ticket in order to join an event in the form of a hockey game. An image of at least a portion of the ticket is captured (1101). The image is processed to determine seat location and game (1102). Here, the image is indicative of Section 19, Row C, seat 23 for the November 15th hockey game. The seat, and game, once extracted, are stored in association with the individual (1103) and an event is created related to the game and the individual (1104). Associated with the event, is an event timeline and the event timeline is provided with an entry that the ticket was scanned or purchased as the case may be.

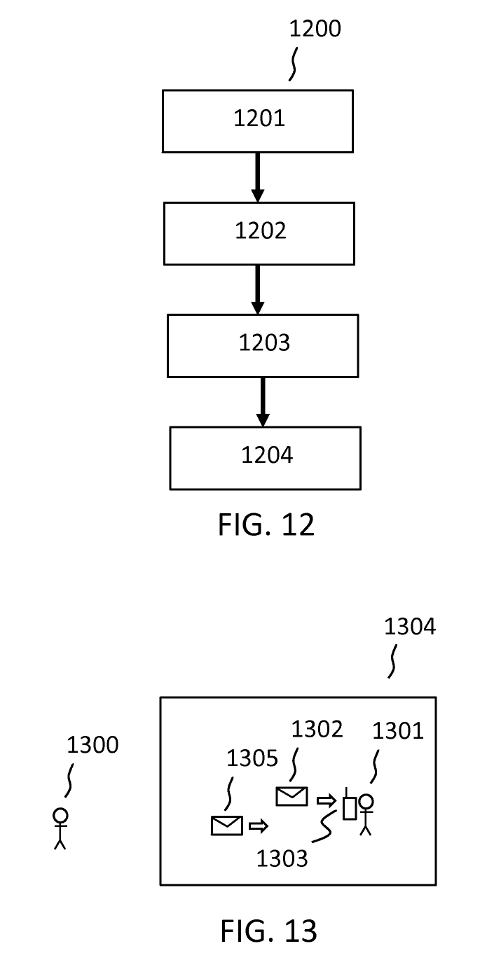

Shown in FIG. 12 is a method 1200 for scanning tickets according to an embodiment of the invention. The individual takes a picture of his event ticket using his smartphone or other device comprising a camera (1201). The image of the ticket is converted into machine encoded text via optical character recognition software (1202). The machine encoded text is searched for seat data, such as section, row and seat number (1203). The seat data is utilized for notifying a friend that the individual has joined or is in attendance of the event (1204). Optionally, the seat data is used to generate a seating map of the event venue indicating the seat location on the map. The seat map is displayed on his smartphone or other electronic device comprising a display.

Alternatively, the individual takes a picture of the barcode of his event ticket using his smartphone or other device comprising a camera (1201). The image of the barcode is deciphered and is searched for seat data, such as section, row and seat number. The seat data is utilized for notifying a friend that the individual has joined or is in attendance of the event. Optionally, the seat data is used to generate a seating map of the event venue indicating the seat location on the map. The seat map is displayed on his smartphone or other electronic device comprising a display. Alternatively, the barcode is deciphered and is correlated with event venue data for determining seat data such as section, row and seat number.

Alternatively, the seat data is utilized for notifying a friend that the individual has joined or is in attendance at the event. According to an embodiment, a first individual joins an event. The first individual is able to identify that a second individual, the second individual being other than a friend via a social network, has also joined the event. For example, a celebrity joins an event and arrives at an event venue. Individuals that have joined the same event have the ability to determine that the celebrity has joined and arrived at the event venue. Shown in FIG. 13 is celebrity 1300 who joins a hockey game event. The first individual 1301 receives a first notification, for example a text message 1302 on the first individual's mobile device 1303, that celebrity 1300 has joined the hockey game event. Furthermore, when celebrity 1300 arrives at the venue in the form of a hockey arena 1304 and checks into the hockey game event the first individual 1301 receives a second notification, for example a second text message 1305 on the first individual's mobile device 1303, that celebrity 1300 has arrived at the hockey arena. Optionally, the first individual “subscribes to” or “follows” the celebrity using, for example, event software in order for the first individual to receive indications that the celebrity has joined and checked into an event as well as other celebrity related event activity.

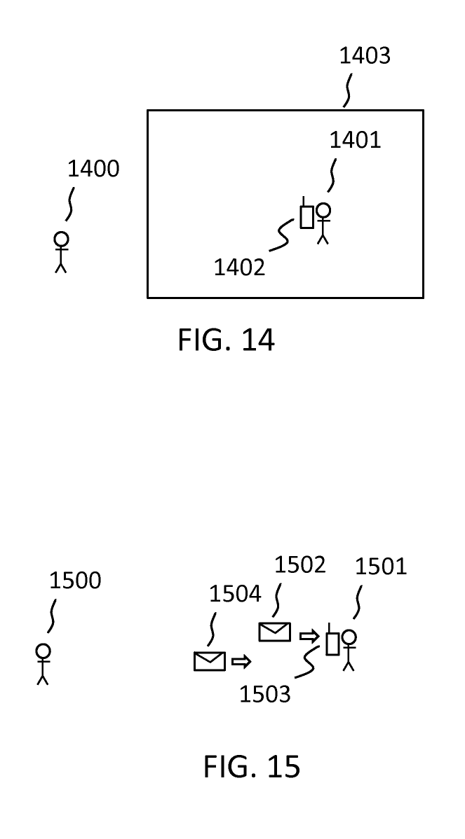

According to another embodiment a first individual joins an event. The first individual is able to identify that a second individual, the second individual being other than a friend via a social network, has also joined the event. For example, a celebrity joins an event and arrives at an event venue. Individuals that have joined the same event have the ability to determine that the celebrity has joined the event and arrived at the event venue. For example shown in FIG. 14 is celebrity 1400 who joins a hockey game event. The first individual 1401 that uses event software running on an electronic device, for example smartphone 1402, to determine if the celebrity 1400 has joined and checked into the event. The first individual 1401 enters the name of the celebrity 1400 in a search box of the event software. The event software indicates to the first individual 1401 that the celebrity 1400 has joined the event. The celebrity 1400 arrives at the event venue in the form of hockey arena 1403 and checks into the hockey game event. The first individual 1401 enters the name of the celebrity 1400 again in the search box of the event software. The event software indicates to the first individual that the celebrity 1400 has arrived at the hockey arena. Alternatively, the event software provides a list of individuals that have joined the event and a list of individuals that have checked into the event. The first individual 1401 searches the lists using the event software for the name of the celebrity 1400. Further alternatively, a list of select members of the event is provided, for example famous members. Alternatively, the electronic device is any device connected to the Internet.

Optionally, any first individual, celebrity or otherwise, has an ability to make “public”—public to all the individuals joined to an event or alternatively to all individuals—the first individual's event activity. To allow public visibility of first individual's event activity, the first individual's privacy settings are configured to allow experiences in the first individual's timeline to be accessible, for example to all the other individuals that have joined the event. The first individual need not be “friends” with the public to share the first individual's timeline experiences. In a first example shown in FIG. 15, a first individual 1500 configures the first individual's privacy settings of his event timeline “public” and as such when the first individual joins an event all of the other individuals 1501 joined to the event receive notifications, for example a first text message 1502 on a mobile device 1503, indicating that the first individual has joined the event. Similarly, when the first individual 1500 checks into an event all of the other individuals 1501 joined to the event receive notifications, for example a second text 1504 message on mobile device 1503, indicating that the first individual 1500 has checked into the event. Optionally, the other individuals 1501—the public—have the option to opt out of receiving such notifications. Optionally, for the public to receive notifications that a first individual has joined or checked into an event, another individual “subscribes to” or “follows” the first individual via the event software.

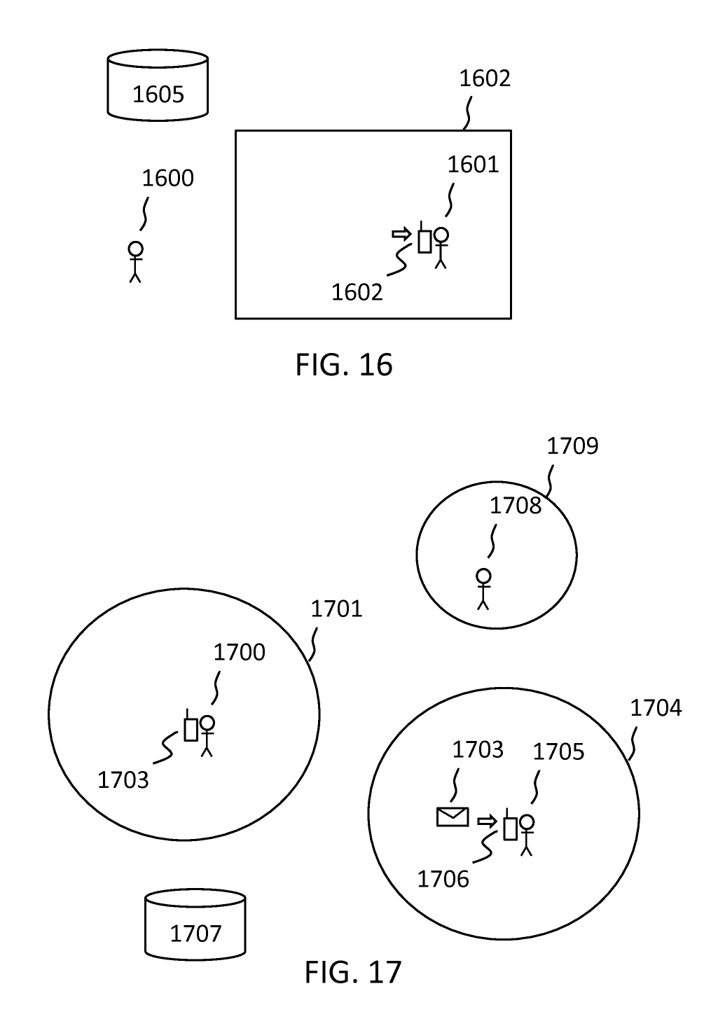

In a second example, a first individual configures first individual's privacy settings such that his event timeline activities are available to the public. Members of the public need not be “friends” of the first individual. Shown in FIG. 16, is a first individual John 1600, whom joins an event, for example a baseball game event, and configures his privacy settings such that every other individual joined to the baseball event has access to his timeline experiences. When John joined the baseball game event John's name was added to the event data store 1605. Anyone in the public may search for John's name using event software. For example, John 1600 works with Tim 1601; however they are not “friends” via a social network. John 1600 had mentioned to Tim 1601 that John 1600 would be going to a same baseball game as Tim 1601. Tim 1601 uses event software running on an electronic device, for example, smartphone 1602, to determine if John 1600 has joined and checked into the event. Tim 1601 enters John's name in a search box of the event software. The event software indicates to Tim 1601 that John 1600 has joined the event. Tim 1601 assumes that John 1600 is on his way to the baseball game. John 1600 arrives at the baseball game 1602 and checks into the baseball game event. Tim 1601 enters John's name in a search box of the event software. The event software indicates to Tim 1601 that John 1600 has arrived at the baseball game. Optionally, the GPS is John's mobile device 1603 enables Tim 1601 to see on a map displayed on Tim's mobile device 1602 where in the baseball stadium John 1600 is located. Tim 1601 goes to John's location to say “hello” to John 1600. Alternatively, the event software provides a list of individuals that have joined the event and a list of individuals that have checked into the event. Using the event software running on Tim's mobile device 1604, Tim 1601 searches the lists for John's name to determine if John 1600 has yet arrived at the baseball game. Alternatively, the electronic device is any device connected to the Internet.

According to an embodiment, all of the individuals that have joined an event have the ability to receive notifications that the first individual has joined and/or checked into an event, to search the status of the first individual with reference to whether the first individual has joined or checked into the event, to have an indication of the first individual's seat location, have an indication of the location of the first individual when privacy settings of the first individual permit same and have visibility to the first individual's timeline experiences.

In the example described with reference to FIG. 16, Tim 1601 has the ability to determine John's location within the event venue, the baseball stadium. In another example, a first individual is aware of a second individual's location wherein the second individual has joined an event but is not “checked into” or located at the event venue. Shown in FIG. 17 is Mary 1700 who has joined the Super Bowl event and is located in a first pub 1701 near the football stadium 1702. Mary 1700 is interested to know if Sue 1705 is attending any of the Super Bowl festivities. Mary 1700 searches for Sue's name using event software running on an electronic device, for example, smartphone 1703. The event software provides Mary 1700 the information that Sue 1705 has joined the Super Bowl event and is located in a second pub 1704 located a few blocks from the first pub 1701. Sue's smartphone's 1706 GPS interacts with the event data store 1707 enabling Mary 1700 to have access to Sue's location. Mary 1700 texts Sue 1702 using smartphone 1703 telling her that Mary 1700 is on her way to meet Sue 1705 at the second pub 1704. Once Mary 1700 arrives at the second pub 1704 she looks for Sue 1705; however the pub 1704 is very crowded and Mary 1700 cannot see Sue 1705. Using a map displayed in the event software, Mary 1700 is able to determine where in the second pub 1704 Sue 1705 is located. Sue 1705 configured her privacy settings to allow the “public” to have access to her location. Alternatively, Sue 1705 and Mary 1700 are “friends” and Sue 1705 has configured her privacy settings to allow her “friends” to have access to her location. Alternatively, the electronic device is any device connected to the Internet.

Referring again to FIG. 17, Mary is interested to know if Erik 1708 is also attending any of the Super Bowl festivities. Erik 1708 is other than a friend via a social network. Mary 1700 searches for Erik's name using event software running on an electronic device, for example, smartphone 1703. The event software provides Mary 1700 the information that Erik 1708 has joined the Super Bowl event and where he is located. Erik 1708 is on vacation in Spain 1709 and is watching the Super Bowl from his vacation home. Erik's smartphone's GPS interacts with the event data store enabling Mary 1700 to have access to Erik's location. Erik 1708 and Mary 1700 exchange texts discussing the Super Bowl festivities that they both are attending. Erik 1708 configured his privacy settings to allow the “public” to have access to his location. Alternatively, Erik configured his privacy settings to allow certain individuals such as friends of friends to access his location. Alternatively, the electronic device is any device connected to the Internet.

Mary 1700 is interested in knowing who else may be joined into the Super Bowl event. Using the event software Mary 1700 peruses the list of individuals who have joined the event and where they are located, for example the city, state and country. Mary 1700 notices that individuals from around the world have joined the event. The event software has several searching algorithms to find individuals. To determine if Mary knows anyone else who has joined the Super Bowl event, Mary 1700 searches for individuals that are located in her city. Mary 1700 uses the event software to search for individuals by city. Mary recognizes several names of individuals she knows. Some of the individuals Mary 1700 knows well, other individuals Mary 1700 only knows by name. In the list Mary 1700 notices that the Mayor of her city is attending the Super Bowl as well as several celebrities.

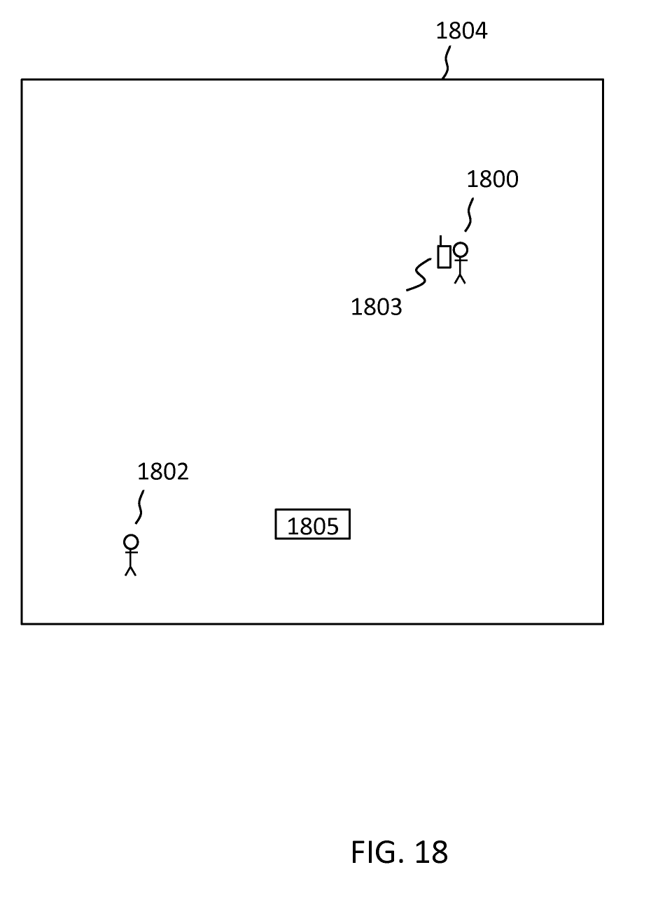

Shown in FIG. 18 is a first individual, Jim 1800, in attendance at a hockey game in arena 1804. Jim 1800 has joined and checked into the hockey game. Using the event software, Jim searches to find other individuals that are also in attendance at the hockey game. For example, Jim finds that a famous retired hockey 1802 player is in attendance. On a map of the local area displayed on Jim's electronic device for example, smartphone 1803, Jim sees an indication of the location of the retired hockey player inside the arena 1804. Furthermore, there are local cameras 1805 in the arena 1804 that feeds to event software live video feeds. Using the event software Jim accesses a camera feed that shows the area in the stands where the retired hockey player is sitting. Jim is able to view live or delayed video of the retired player and the other individuals he is sitting with on his smartphone 1803. Optionally, Jim finds many other individuals he knows that have joined the hockey game event. The event software displays the locations of each of the other individuals on a map, for example of the local area. Some of the other individuals are not located in the arena but are located in other venues surrounding the arena and beyond. Of course, as long as the video cameras in those locations are also configured for use with the system, the first individual can also see the comings and goings on at those venues. For example, when Jim 1800 has a friend at the sports bar in his neighborhood, he can switch to the live video feed from that sports bar and watch his friend enjoying the game. Jim's friend can select the live video feed near Jim 1800 to watch Jim and his activities during a same game. Alternatively, the electronic device is any device connected to the Internet.

As used herein the terms he and she are representative of an individual and is to be seen as including individuals of all sexes.

Numerous other embodiments may be envisaged without departing from the scope of the invention.

What is claimed is:

1. A method comprising
checking into an event by an individual using an electronic device, the electronic device in communication with a communication network;
searching for first event data relating to the individual in an event data store, the event data store in communication with the communication network;
when the first event data is other than found, storing first event data relating to the individual in the event data store via the communication network; and
storing location data in the event data store relating to a location of the individual within a venue via the communication network.

2. A method according to claim 1 wherein checking into the event comprises scanning a ticket for the event.

3. A method according to claim 2 wherein scanning is performed using a mobile communication device of the individual.

4. A method according to claim 1 wherein checking into the event comprises scanning a QR code relating to a venue and the event.

5. A method according to claim 4 wherein scanning is performed using a mobile communication device of the individual.

6. A method according to claim 1 comprising:
searching for a second individual attending the event and relating to the first individual, the second individual having checked into the event; and
in response to the search, notifying the first individual of the presence at the event of the second individual via a transducer of the electronic communication device.

7. A method according to claim 6 comprising:
automatically providing a communication channel between the individual and the second individual for supporting real-time communication therebetween.

8. A method according to claim 1 comprising:
searching for a second individual attending the event and relating to the first individual via a social networking connection, the second individual having checked into the event; and
in response to the search, notifying the first individual that the second individual has checked in via a transducer of the electronic communication device.

9. A method according to claim 8 comprising:
automatically providing a communication channel between the individual and the second individual for supporting real-time communication therebetween.

10. A method according to claim 1 comprising:
using the electronic communication device to retrieve a list of those individuals in attendance and data associated therewith which is available for access by the first individual via the communication network; and
displaying via a transducer of the electronic communication device the retrieved list.

11. A method according to claim 10 comprising:
automatically providing a communication channel between the individual and at least someone on the retrieved list for supporting real-time communication therebetween.

12. A method according to claim 1 comprising:
using the electronic communication device to retrieve a list of those individuals in attendance and data associated therewith which is available for access by the first individual via the communication network; and
inviting individuals within the retrieved list to join the event.

13. A method comprising
scanning a portion of a ticket for ticket data relating to an event and an individual by an electronic device, the electronic device in communication with a communication network;
searching for first event data relating to the individual in an event data store, the event data store in communication with the communication network;
when the first event data is other than found, storing first event data relating to the individual in the event data store via the communication network; and
storing the ticket data in the event data store, the ticket data relating to the individual, the actual event, and the ticket data via the communication network.

14. The method according to claim 13 wherein scanning a portion of the ticket comprises imaging the ticket text by the electronic device and utilizing optical character recognition software to detect ticket data.

15. The method according to claim 13 wherein scanning a portion of the ticket comprises imaging a barcode in the ticket by the electronic device and decoding the barcode to form ticket data.

16. The method according to claim 13 comprising:
based on a first location of the second individual, providing a video feed to the electronic communication device of the first individual from a video source one of proximate the first location and for capturing video information from a location proximate the first location.

17. The method according to claim 13 comprising:
based on a first location of the second individual, providing a video feed to the electronic communication device of the first individual from a video source selectably adjustable to capture video information from the first location.

18. A method comprising
checking into an event by an individual using an electronic device, the electronic device in communication with a communication network;
checking into the event by a second individual using a second electronic device, the second electronic device in communication with the communication network;
searching for first event data relating to the individual in an event data store, the event data store in communication with the communication network;
searching for first event data relating to the second individual in an event data store, the event data store in communication with the communication network; and
notifying the individual that the second individual has checked into the event.
